(19) United States
(12) Patent Application Publication
(10) Pub. No.: US 2018/0057763 A1
(43) Pub. Date: Mar. 1, 2018

(54) METHODS AND SYSTEMS FOR DECREASING EMISSIONS OF CARBON DIOXIDE FROM COAL-FIRED POWER PLANTS

(71) Applicant: Soap Creek Energy, Larkspur, CO (US)

(72) Inventor: Michael D. Durham, Gunnison, CO (US)

(21) Appl. No.: 15/619,815

(22) Filed: Jun. 12, 2017

Related U.S. Application Data
(60) Provisional application No. 62/381,035, filed on Aug. 30, 2016.

(51) Int. Cl. C10L 9/08; F03D 9/18; F03B 13/14; F03G 6/06; F03G 6/00

(52) U.S. Cl. CPC C10L 9/08; F03D 9/18; F03B 13/14; F03G 6/06; C10L 2290/36; C10L 2290/08; C10L 2290/28; C10L 2290/30; F03G 6/001

(57) ABSTRACT

Methods and systems for reducing carbon dioxide emissions from a coal-fired power plant by using electrical energy from a renewable energy source to increase the energy density in a beneficiated coal are provided. The system includes at least one renewable energy source; a coal processing plant, wherein the renewable energy source is configured to power a coal beneficiation process; and a coal-fired power plant to combust beneficiated coal to produce electricity on demand with decreased emissions. The non-carbon thermal energy source may include solar thermal energy, geothermal energy, waste energy and combinations of the foregoing.

### FIELD OF THE INVENTION

This invention relates to methods and systems to enhance the beneficiation and drying of solid fuels, in particular low rank coals, with non-carbon energy sources. More particularly the invention relates to using solar thermal, geothermal and biomass combustion as supplemental sources of thermal energy to support the beneficiation/drying of coal in order to reduce the lifecycle emissions of carbon dioxide from coal-fired electricity generation.

### BACKGROUND OF THE INVENTION

Traditionally, fossil fuels have been used to generate both the electricity and the thermal energy needed to remove moisture and dry coal in a coal processing plant. However, due to the concerns about the impact on climate from increased carbon dioxide (CO₂) emissions from fossil fuel combustion, there has been a worldwide effort to curb emissions of carbon dioxide in the generation of electrical power by either capturing and storing the carbon (CCS), or by switching from coal-burning production plants to renewable electrical energy power/electricity generation, or by increasing the efficiency of generation. CCS technologies are relatively new and unproven and are associated with high costs and high energy penalties. While renewable electrical energy produces electricity without carbon emissions, the renewable generation sources suffer from several drawbacks that limit their usefulness as alternatives to fossil fuel. Power generation by renewable electrical energy sources may be intermittent and inconsistent and can vary seasonally, diurnally, or be subject to instantaneous interruption depending on whether the wind is blowing or the sun is shining. Thus, renewable electrical energy sources of power are unpredictable because of their dependence upon micro- and macro-climatic conditions. Because the power generation from renewables may be intermittent and inconsistent, the power generation may or may not coincide with the timing of demand from power consumers, e.g. at night for solar power sources. Additionally, the optimum locations for renewable generation, such as the desert areas in the West maximize solar generation and remote areas of Wyoming and the Dakotas for wind, are not located near population or industrial centers, creating issues in the transmission of the electricity to places where it is needed. Moreover, the intermittency creates rapid response requirements for conventional power generation that produces stress on equipment and limits how much renewable electrical energy can be effectively integrated onto the energy supply grid.

An alternative to these processes is to decrease the amount of emissions of carbon dioxide from coal-fired power plants by beneficiating and/or drying the coal prior to combustion. This results in a higher density of energy in the coal, which reduces the volume of coal required to produce a given amount of electricity, thus reducing the carbon emissions associated with that electrical generation. However, the various coal beneficiation/drying processes all require significant amounts of thermal energy to dry the coal. If these energy sources are associated with carbon dioxide generating processes, the overall environmental improvement from coal drying is reduced or even eliminated in some cases.

Therefore, a need exists to use non-carbon, clean thermal energy as a supplemental energy source to dry and beneficiate coal for later use in the generation of electricity on demand. A need also exists to provide systems and methods for supplementing the drying of coal with non-carbon energy sources in order to reduce the overall carbon emissions associated with the production of electricity. A need also exists to maintain grid reliability by providing electricity on demand using a supplemental non-carbon thermal energy source to keep electricity affordable. A need also exists for the long-term storage of clean energy.

### BRIEF SUMMARY OF THE INVENTION

The present invention addresses the foregoing needs by providing systems and methods for interfacing non-carbon thermal energy sources, such as solar thermal, geothermal and biomass combustion, with coal beneficiation and drying to produce an increased energy density coal. This will reduce the carbon emissions associated with the beneficiation of coal while also providing for the short to long-term storage of renewable thermal energy with subsequent conversion to electricity on demand as and when needed.

Advantageously, the invention results in reduced CO₂ emissions in several different ways. By providing non-carbon thermal energy sources for the beneficiation and drying of coal, the beneficiation process has a lowered CO₂ output. Furthermore, beneficiated and dried coal produces less CO₂ per unit of electricity generated than non-beneficiated coal due to the increased stored energy content of beneficiated coal and the reduced energy loses during combustion due to latent heat of vaporization of water in the coal. The reduced volume of coal burned to produce a given quantity of electricity reduces parasitic losses in the plant, which leads to additional reductions in CO₂ emissions.

Accordingly, in some aspects, the present invention is directed to systems and methods for increasing the stored energy content of coal. In some aspects, the coal may include peat coal, lignite coal, sub-bituminous coal, bituminous coal, anthracite coal and combinations of the foregoing. In some aspects, the method comprises providing non-carbon thermal energy sources from solar thermal, geothermal or biomass combustion to dry and beneficiate coal.

In some aspects, the present invention is directed to systems and methods for supplementing coal drying/beneficiation processes that are designed to increase the stored energy content of coal such as those disclosed in U.S. Application Publ. Nos. [Attorney Docket No. 161487.00002 entitled Methods and Systems for Storage of Renewable Energy Sources in Increased Energy Density Coal, filed on Jun. 12, 2017 and Atty. Docket No. 161487.00005 entitled Methods and Systems for the Storage of Nuclear Energy in Increased Energy Density Coal, filed Jun. 12, 2017], hereby incorporated by reference in its entirety. In some aspects, the supplemental thermal energy may be used with any beneficiating process that uses any kind of energy including electricity generated from fossil fuel sources or renewable energy sources. In some aspects the coal may include peat coal, lignite coal, sub-bituminous coal, bituminous coal, anthracite coal and combinations of the foregoing. In some aspects, the method to provide non-carbon energy to enhance coal beneficiation processes comprises thermal energy from solar thermal, geothermal and/or biomass combustion. The energy provided by the non-carbon source reduces the carbon emissions from combusting fossil fuels associated with the coal beneficiation process.

In some aspects, a system for reducing carbon dioxide emissions from a coal-fired power plant by using electrical energy from a renewable energy source to increase the energy density in a beneficiated coal is provided. The system includes at least one renewable energy source; a coal processing plant, wherein the renewable energy source is configured to input energy into a coal beneficiation process; and a coal-fired power plant to combust the beneficiated coal to produce electricity on demand with decreased emissions.

In some aspects, the renewable energy source is selected from hydroelectric power, solar power, wind power, wave power, and combinations thereof.

In some aspects, the solar power includes either photovoltaic panels or a concentrated solar thermal system.

In some aspects, the coal beneficiation process involves reducing a moisture content of the coal to increase an energy density of the coal. In some aspects, the coal beneficiation process is configured to convert electrical energy to mechanical energy to reduce the moisture content of the coal. In some aspects, the mechanical energy to reduce moisture content comprises high-pressure compaction.

In some aspects, the coal processing plant is configured to convert electrical power to microwave energy to reduce the moisture content of the coal.

In some aspects, the coal beneficiation process further comprises the addition of a halogen to the coal beneficiation process.

In some aspects, the coal beneficiation process further comprises a removal of sulfur-containing compounds from said coal.

In some aspects, the system includes a thermal energy source configured to reduce a quantity of the electrical energy necessary to power the beneficiation process. In some aspects, the thermal energy is selected from fossil fuel combustion, waste energy, and combinations of the foregoing.

In some aspects, the waste energy is selected from waste heat and/or low-quality steam generated from a power plant or industrial process.

In some aspects, a location of the coal processing plant is selected from a coal mine, a coal transportation terminal, a coal-fired power plant, a same site as the renewable energy source and combinations of the foregoing.

In some aspects, the coal transportation terminal is selected from terminals providing access to a ship, rail, barge, truck, and combinations of the foregoing. In other aspects, the coal processing plant is integrated with a coal-fired power plant and shares use of coal handling, coal crushing and coal conveying equipment.

In some aspects, a system to provide storage of electricity from a renewable energy source by using the renewable electricity to power a coal processing plant which dries coal resulting in an increased energy density coal is provided. The system includes a coal processing plant; at least one renewable energy source configured to input energy into a coal beneficiation process in the coal processing plant to produce the increased energy density coal that stores the inputted energy; and a coal-fired power plant configured to convert the stored renewable energy in the increased energy density coal to electricity on demand.

In some aspects, the increased energy density coal is configured to be stored, transported and later combusted to produce said electricity on demand.

In some aspects, the renewable energy source is selected from hydroelectric power, solar power, wind power, wave power, and combinations thereof.

In some aspects, the solar power comprises either photovoltaic panels or a concentrated solar thermal system.

In some aspects, the coal beneficiation process involves reducing the moisture content of the coal to increase the energy density.

In some aspects, the coal beneficiation process converts electrical energy to mechanical energy to reduce the water content of the coal. In some aspects, the mechanical energy to reduce the water content of coal comprises high-pressure compaction.

In some aspects, the coal processing plant is configured to convert electrical power to microwave energy to remove moisture from the coal.

In some aspects, the system includes a thermal energy source configured to reduce a quantity of electrical energy necessary to beneficiate the coal. In some aspects, the thermal energy is selected from fossil fuel combustion, waste energy, and combinations of the foregoing. In other aspects, the waste energy is selected from waste heat and/or low-quality steam generated from a power plant or industrial process.

In some aspects, a location of the coal processing plant is selected from a coal mine, a coal transportation terminal, a coal-fired power plant, a same site as the renewable energy source and combinations of the foregoing. In some aspects, the coal transportation terminal is selected from terminals providing access to a ship, rail, barge, truck, and combinations of the foregoing. In other aspects, the coal processing plant is integrated with a coal-fired power plant and shares use of coal handling, coal crushing and coal conveying equipment.

In some aspects, the non-carbon energy source may include a solar thermal energy source. In some aspects, the solar thermal energy source includes a low-pressure solar thermal system. In some aspects, low-pressure solar thermal systems that operate at temperatures below 150 degrees Centigrade (C) prevent pre-combustion of the coal. In some aspects, low-pressure solar thermal systems may include lower cost solar thermal panels. In some aspects, the solar thermal panels may include a low-pressure gravity feed system and an insulated storage tank. In some aspects, the tubes are filled with water or a working fluid and exposed to the sun thus heating up the liquid in the tubes. The heat generated from the solar thermal panels is used to either pre-heat the coal or is incorporated into the coal drying process. In some aspects, the coal is heated at temperatures below 120 degrees C. In some aspects, the coal is heated at temperatures below 115 degrees C. In some aspects, the coal is heated at temperatures below 150 degrees C. In some aspects, the coal is heated at temperatures below 145 degrees C. In some aspects the coal is heated at temperatures below 140 degrees C. In some aspects, the coal is heated at temperatures below 135 degrees C. In some aspects, the coal is heated at temperatures below 130 degrees C. In some aspects, the coal is heated at temperatures below 125 degrees C. In some aspects, the coal is heated at temperatures below 120 degrees C. In some aspects, the coal is heated at temperatures below 115 degrees C. In some aspects, the coal is heated at temperatures below 110 degrees C. In some aspects, the coal is heated at temperatures below 100 degrees C. In some aspects, the coal is heated at temperatures below 95 degrees C. In some aspects, the coal is heated at temperatures below 90 degrees C. In some aspects, the coal is heated at temperatures below 85 degrees C. In some aspects, the coal is heated at temperatures below 80 degrees C.

In some aspects, the solar thermal power source includes a concentrated, high-pressure solar thermal system to provide thermal energy to the coal. In some aspects, the concentrated/high-pressure solar thermal systems operate at temperatures above 125 degrees Centigrade (C). In some aspects, high-pressure solar thermal systems may include solar thermal panels. In some aspects, the solar thermal panels may include evacuated tubes and heat pipes. In some aspects, the evacuated glass tubes absorb solar energy and converts it to heat energy. In some aspects, the coal is heated at temperatures above 125 degrees C. In some aspects, the coal is heated at temperatures above 130 degrees C. In some aspects, the coal is heated at temperatures above 135 degrees C. In some aspects, the coal is heated at temperatures above 140 degrees C. In some aspects, the coal is heated at temperatures above 150 degrees C. In some aspects, the coal is heated at temperatures above 160 degrees C. In some aspects, the coal is heated at temperatures above 165 degrees C. In some aspects, the coal is heated at temperatures above 170 degrees C. In some aspects, the coal is heated at temperatures above 175 degrees C. In some aspects, the coal is heated at temperatures above 180 degrees C. In some aspects, the coal is heated at temperatures above 185 degrees C. In some aspects, the coal is heated at temperatures above 190 degrees C. In some aspects, the coal is heated at temperatures above 195 degrees C. In some aspects, the coal is heated at temperatures above 200 degrees C. In some aspects, the coal is heated at temperatures above 205 degrees C. In some aspects, the coal is heated at temperatures above 210 degrees C. In some aspects, the coal is heated at temperatures above 215 degrees C. In some aspects, the coal is heated at temperatures above 220 degrees C. In some aspects, the coal is heated at temperatures above 225 degrees C. In some aspects, the coal is heated at temperatures above 230 degrees C. In some aspects, the coal is heated at temperatures above 235 degrees C. In some aspects, the coal is heated at temperatures above 240 degrees C. In some aspects, the coal is heated at temperatures above 250 degrees C. In some aspects, the coal is heated at temperatures above 260 degrees C. In some aspects, the coal is heated at temperatures above 265 degrees C. In some aspects, the coal is heated at temperatures above 270 degrees C. In some aspects, the coal is heated at temperatures above 275 degrees C. In some aspects, the coal is heated at temperatures above 280 degrees C. In some aspects, the coal is heated at temperatures above 285 degrees C. In some aspects, the coal is heated at temperatures above 290 degrees C. In some aspects, the coal is heated at temperatures above 295 degrees C. In some aspects, the coal is heated at temperatures above 300 degrees C. In some aspects, the coal is heated at temperatures above 305 degrees C. In some aspects, the coal is heated at temperatures above 310 degrees C. In some aspects, the coal is heated at temperatures above 315 degrees C. In some aspects, the coal is heated at temperatures above 330 degrees C. In some aspects, the coal is heated at temperatures above 335 degrees C. In some aspects, the coal is heated at temperatures above 330 degrees C. In some aspects, the coal is heated at temperatures above 335 degrees C. In some aspects, the coal is heated at temperatures above 340 degrees C. In some aspects, the coal is heated at temperatures above 350 degrees C.

In some aspects, the solar thermal energy source includes the use of heat exchangers to convert the solar thermal working fluid to heated gas, which is used in the beneficiation of the coal. In some aspects, the solar thermal power source includes the use of heat exchangers to convert the solar thermal working fluid to steam, which is used in the beneficiation of the coal. In some aspects, the solar thermal power source includes the use of a supplemental gas fired burner to provide heat when solar thermal is no longer providing sufficient heat. In some aspects, the heated fluid produced by the solar thermal power source is stored in insulated storage tanks to store energy from the solar thermal process so that the heated fluid can provide a continuous source of heat for beneficiating the coal. In some aspects, water may be heated by exposing it to the solar thermal power source. The heated water may be passed through tubes in a heat exchanger while cool air is passed on the outside of the tubes. The heat from the water heats the air and the heated air is then passed through another heat exchanger to heat a working fluid. The heated working fluid can then be used in the beneficiation process.

In some aspects, the non-carbon energy source may include using a geothermal power source. In some aspects, the geothermal energy source includes a moderate to low-temperature geothermal system. In some aspects, moderate to low-temperature geothermal systems operate at temperatures between 70 degrees C. and 150 degrees C. In some aspects, low-pressure geothermal systems may include tapping into a hot reservoir underground. In some aspects, the geothermal systems may include heat pumps and ground source collectors. In some aspects, collected fluid may be stored in insulated storage tanks. The heat generated from the moderate to low-temperature geothermal systems is used to beneficiate the coal by heating it at temperatures below 150 degrees C. In some aspects, the coal is beneficiated at temperatures below 145 degrees C. In some aspects, the coal is beneficiated at temperatures below 140 degrees C. In some aspects, the coal is beneficiated at temperatures below 135 degrees C. In some aspects, the coal is beneficiated at temperatures below 130 degrees C. In some aspects, the coal is beneficiated at temperatures below 125 degrees C. In some aspects, the coal is beneficiated at temperatures below 120 degrees C. In some aspects, the coal is beneficiated at temperatures below 115 degrees C. In some aspects, the coal is beneficiated at temperatures below 110 degrees C. In some aspects, the coal is beneficiated at temperatures below 105 degrees C. In some aspects, the coal is beneficiated at temperatures below 100 degrees C. In some aspects, the coal is beneficiated at temperatures below 95 degrees C. In some aspects, the coal is beneficiated at temperatures below 90 degrees C. In some aspects, the coal is beneficiated at temperatures below 85 degrees C. In some aspects, the coal is beneficiated at temperatures below 80 degrees C. In some aspects, the coal is beneficiated at temperatures below 75 degrees C. In some aspects, the coal is beneficiated at temperatures below 70 degrees C.

In some aspects, the geothermal power source includes a high-pressure geothermal system for beneficiating the coal. In some aspects, high-pressure geothermal systems operate at temperatures above 180 degrees Centigrade (C). In some aspects, high-pressure geothermal systems may include may include tapping into a hot reservoir underground. In some aspects, the high-pressure geothermal system may include heat pipes. In some aspects, hot geothermal fluids are passed through one side of a heat exchanger to heat a working fluid in a separate adjacent pipe. In some aspects, geothermal heat pumps use a system of buried pipes linked to a heat exchanger. The heat and steam generated from the high-pressure geothermal systems is used to beneficiate the coal by heating it at temperatures between 150 degrees C. and 220 degrees C. In some aspects, the coal is heated at temperatures above 150 degrees C. In some aspects, the coal is heated at temperatures above 155 degrees C. In some aspects, the coal is heated at temperatures above 160 degrees C. In some aspects, the coal is heated at temperatures above 165 degrees C. In some aspects, the coal is heated at temperatures above 170 degrees C. In some aspects, the coal is heated at temperatures above 175 degrees C. In some aspects, the coal is heated at temperatures above 180 degrees C. In some aspects, the coal is heated at temperatures above 185 degrees C. In some aspects, the coal is heated at temperatures above 190 degrees C. In some aspects, the coal is heated at temperatures above 195 degrees C. In some aspects, the coal is heated at temperatures above 200 degrees C. In some aspects, the coal is heated at temperatures above 205 degrees C. In some aspects, the coal is heated at temperatures above 210 degrees C. In some aspects, the coal is heated at temperatures above 215 degrees C. In some aspects, the coal is heated at temperatures above 220 degrees C.

In some aspects, the geothermal power source includes the use of heat exchangers to convert the geothermal working fluid to heated gas, which is used to beneficiate the coal. In some aspects, the geothermal power source includes the use of heat exchangers to convert the geothermal working fluid to steam, which is used to beneficiate the coal. In some aspects, the geothermal power source includes the use of a supplemental gas fired burner to provide heat when geothermal in no longer providing sufficient heat. In some aspects, the heated fluid produced by the geothermal power source is stored in insulated storage tanks to store energy from the geothermal process so that the heated fluid can provide a continuous source of heat for beneficiating the coal.

In yet other aspects of the invention the non-carbon thermal energy source may be produced from the combustion of biomass. Biomass is fuel generated from organic materials such as crops, lumber, manure/waste, compost, and biofuels such as ethanol or oils. Biomass is a relatively small but growing energy source, currently representing approximately 5% of energy generated in the United States. One advantage of biomass combustion is that it can be combusted practically anywhere, and as such may represent the most mobile of non-carbon energy sources; however there often must be a source of biomass nearby as the cost of shipping biomass and energy used for transportation may be prohibitive. Another advantage of biomass combustion is that it recycles waste that would otherwise occupy landfills. Additional, the amount of biomass that can be co-fired with conventional fuels is often limited to around 10% due to detrimental impacts to the boiler caused by chemicals in the biomass. However, with the invention described here, the biomass can be burned in a boiler specifically designed for firing biomass. A heat recovery steam generator is incorporated with the boiler to recover thermal energy to be supplied to the beneficiation process.

The non-carbon sources of energy are used as supplemental sources of energy to beneficiate the coal to reduce water content thereby enhancing the drying of the coal in the beneficiation process. This effectively reduces the carbon footprint of coal burning facilities by supplementing and thereby reducing the amount of power from any energy source used to burn coal. This includes any energy used with beneficiating processes such as electricity generated from renewable energy sources, thermal energy from waste energy, fossil fuels and other sources, and zero carbon energy.

In some aspects, the use of non-carbon sources to beneficiate coal comprises reducing the water content of coal. In some aspects, the total water content of coal may be reduced by about 5%. In some aspects, the total water content of coal may be reduced by about 10%. In some aspects, the total water content of coal may be reduced by about 15%. In some aspects, the total water content of coal may be reduced by about 20%. In some aspects, the total water content of coal may be reduced by about 25%. In some aspects, the total water content of coal may be reduced by about 30%. In some aspects, the total water content of coal may be reduced by about 35%. In some aspects, the total water content of coal may be reduced by about 40%. In some aspects, the total water content of coal may be reduced by about 45%. In some aspects, the total water content of coal may be reduced by about 50%. In some aspects, the total water content of coal may be reduced by about 55%. In some aspects, the total water content of coal may be reduced by about 60%. In some aspects, the total water content of coal may be reduced by about 65%. In some aspects, the total water content of coal may be reduced by about 70%. In some aspects, the total water content of coal may be reduced by about 75%. In some aspects, the total water content of coal may be reduced by about 80%. In some aspects, the total water content of coal may be reduced by about 85%. In some aspects, the total water content of coal may be reduced by about 90%. In some aspects, the total water content of coal may be reduced by about 95%. In some aspects, the total water content of coal may be reduced by about 98%. In some aspects, the total water content of coal may be reduced by about 99%. In some aspects, the total water content of coal may be reduced by greater than 99%.

In some aspects, the total water content of coal may be reduced by about 1% to about 5%. In some aspects, the total water content of coal may be reduced by about 1% to about 10%. In some aspects, the total water content of coal may be reduced by about 5% to about 10%. In some aspects, the total water content of coal may be reduced by about 5% to about 15%. In some aspects, the total water content of coal may be reduced by about 10% to about 15%. In some aspects, the total water content of coal may be reduced by about 10% to about 20%. In some aspects, the total water content of coal may be reduced by about 15% to about 20%. In some aspects, the total water content of coal may be reduced by about 15% to about 25%. In some aspects, the total water content of coal may be reduced by about 20% to about 25%. In some aspects, the total water content of coal may be reduced by about 20% to about 30%. In some aspects, the total water content of coal may be reduced by about 25% to about 30%. In some aspects, the total water content of coal may be reduced by about 25% to about 35%. In some aspects, the total water content of coal may be reduced by about 30% to about 35%. In some aspects, the total water content of coal may be reduced by about 30% to about 40%. In some aspects, the total water content of coal may be reduced by about 35% to about 40%. In some aspects, the total water content of coal may be reduced by about 35% to about 45%. In some aspects, the total water content of coal may be reduced by about 40% to about 45%. In some aspects, the total water content of coal may be reduced by about 40% to about 50%. In some aspects, the total water content of coal may be reduced by about 45% to about 50%. In some aspects, the total water content of coal may be reduced by about 45% to about 55%. In some aspects, the total water content of coal may be reduced by about 50% to about 55%. In some aspects, the total water content of coal may be reduced by about 50% to about 60%. In some aspects, the total water content of coal may be reduced by about 55% to about 60%. In some aspects, the total water content of coal may be reduced by about 55% to about 65%. In some aspects, the total water content of coal may be reduced by about 60% to about 65%. In some aspects, the total water content of coal may be reduced by about 60% to about 70%. In some aspects, the total water content of coal may be reduced by about 65% to about 70%. In some aspects, the total water content of coal may be reduced by about 65% to about 75%. In some aspects, the total water content of coal may be reduced by about 70% to about 75%. In some aspects, the total water content of coal may be reduced by about 70% to about 80%. In some aspects, the total water content of coal may be reduced by about 75% to about 80%. In some aspects, the total water content of coal may be reduced by about 75% to about 85%. In some aspects, the total water content of coal may be reduced by about 80% to about 85%. In some aspects, the total water content of coal may be reduced by about 80% to about 90%. In some aspects, the total water content of coal may be reduced by about 85% to about 90%. In some aspects, the total water content of coal may be reduced by about 85% to about 95%. In some aspects, the total water content of coal may be reduced by about 90% to about 95%. In some aspects, the total water content of coal may be reduced by about 90% to about 98%. In some aspects, the total water content of coal may be reduced by about 95% to about 98%. In some aspects, the total water content of coal may be reduced by about 90% to about 99%. In some aspects, the total water content of coal may be reduced by about 95% to about 99%.

In some aspects, beneficiating coal to reduce water content results in an increase in the stored energy content of the coal thereby enhancing the beneficiation process. In some aspects, the stored energy content may be increased greater than 10%. In some aspects, the stored energy content may be increased greater than 20%. In some aspects, the stored energy content may be increased greater than 30%. In some aspects, the stored energy content may be increased greater than 40%. In some aspects, the stored energy content may be increased greater than 50%. In some aspects, the stored energy content may be increased greater than 60%. In some aspects, the stored energy content may be increased greater than 70%. In some aspects, the stored energy content may be increased greater than 80%. In some aspects, the stored energy content may be increased greater than 90%. In some aspects, the stored energy content may be increased greater than 100%. In some aspects, the stored energy content may be increased greater than 110%. In some aspects, the stored energy content may be increased greater than 120%. In some aspects, the stored energy content may be increased greater than 130%. In some aspects, the stored energy content may be increased greater than 140%. In some aspects, the stored energy content may be increased greater than 150%. In some aspects, the stored energy content may be increased greater than 160%. In some aspects, the stored energy content may be increased greater than 170%. In some aspects, the stored energy content may be increased greater than 180%. In some aspects, the stored energy content may be increased greater than 190%. In some aspects, the stored energy content may be increased greater than 200%. In some aspects, the coal beneficiation process comprises mechanical water reduction.

In some aspects, beneficiating the coal with supplemental non-carbon thermal energy may be performed at a coal preparation plant. In some aspects, the coal preparation plant may be located at a coal mine. In some aspects, the coal preparation plant may be located at a coal transportation terminal. In some aspects, the coal transportation terminal comprises a ship. In some aspects, the coal transportation terminal comprises a barge. In some aspects, the coal transportation terminal comprises a rail. In some aspects, the coal transportation terminal comprises a truck.

### BRIEF DESCRIPTION OF THE DRAWINGS

FIG. 1 is an illustration of one configuration of the invention.

FIG. 2 is an illustration of an alternate configuration of the invention.

### DETAILED DESCRIPTION OF THE INVENTION

There are a number of known coal beneficiation processes in the art, e.g. those as described in U.S. Pat. No. 3,999,958; U.S. Pat. No. 4,252,639; U.S. Pat. No. 4,397,248; U.S. Pat. No. 4,412,842; U.S. Pat. No. 4,632,750; U.S. Pat. No. 4,702,824; U.S. Pat. No. 6,632,258; U.S. Pat. No. 7,901,473; U.S. Pat. No. 8,585,788; U.S. Pat. No. 8,579,998; U.S. Pat. No. 8,647,400; and U.S. Pat. No. 8,925,729 the disclosure of each of which is incorporated by reference in their entirety. However, each of these processes has inherent limitations in that the coal beneficiation processes described therein are not supplemented with a non-carbon thermal energy source so that the net overall environmental impact of such coal beneficiation processes is limited, principally that those coal beneficiation processes require an enormous amount of energy from carbon-generating sources. Thus, even if the end result is a more energy-dense coal product, the net benefit on environmental impact is not reduced or minimized in many circumstances.

The present invention solves this technical problem by integrating non-carbon thermal energy sources to reduce the use of fossil-fuel fired energy sources in the coal beneficiation processes, which reduces the overall environmental impact and provides a consistent energy source in the form of beneficiated coal. Integrating non-carbon thermal energy sources with coal beneficiation processes has a number of distinct potential advantages over the prior art, including advantages over standalone non-carbon thermal energy sources and other stored energy systems.

Some of the advantages are as follows. Integrating non-carbon thermal energy sources with coal beneficiation processes allows for large-scale storage of thermal energy with subsequent generation of energy on demand. In many circumstances, non-carbon energy sources as standalone sources of energy provide insufficient power output for urban cities and other major population centers, especially in the developed and developing world. Beneficiated coal is capable of being produced in an amount to produce hundreds to thousands of megawatts (MWs) of electrical power. For example, beneficiated coal may be produced in an amount sufficient to power a 5 MW rated plant, a 10 MW rated plant, a 25 MW rated plant, a 50 MW rated plant, a 75 MW rated plant, a 100 MW rated plant, a 125 MW rated plant, a 150 MW rated plant, a 175 MW rated plant, a 200 MW rated plant, a 225 MW rated plant, a 250 MW rated plant, a 275 MW rated plant, a 300 MW rated plant, a 325 MW rated plant, a 350 MW rated plant, a 375 MW rated plant, a 400 MW rated plant, a 425 MW rated plant, a 450 MW rated plant, a 475 MW rated plant, a 500 MW rated plant, a 525 MW rated plant, a 550 MW rated plant, a 575 MW rated plant, a 600 MW rated plant, a 625 MW rated plant, a 650 MW rated plant, a 675 MW rated plant, a 700 MW rated plant, a 725 MW rated plant, a 750 MW rated plant, a 775 MW rated plant, a 800 MW rated plant, a 825 MW rated plant, a 825 MW rated plant, a 875 MW rated plant, a 900 MW rated plant, a 925 MW rated plant, a 950 MW rated plant, a 975 MW rated plant, a 1,000 MW rated plant, or plants rated above 1,000 MW, and any intervening ranges therein.

### Example I

Assume a base case of a 500 MW coal-fired power plant with a heat rate of 10,500 BTU/kWh burning 2.2 MT/yr of subbituminous coal from the Powder River Basin with a moisture content of 26% and an energy content of 8900 BTU/lb. A coal beneficiating plant treats all of the 2.2 MT/yr of the coal prior to combustion, in the power plant, reducing the moisture content to 13% and thereby increasing the energy content of the treated coal to 9,900 BTU/lb. In this example, all of the electricity needed to dry the coal, 220,000 MW-hr/yr, is produced by the coal-fired power plant. When the coal is burned in the power plant to make electricity on demand, the combination of synergistic effects and increased generation efficiency results in reducing the emissions of carbon dioxide from the plant. However, the reduction in emissions is offset somewhat by an increase in carbon dioxide emissions associated with electricity used in the coal drying process.

### Example II

Using the system in accordance with the invention, supplemental thermal energy produced by non-carbon sources rated at 30 MBTU/hr is used in the processing plant to enhance the drying of the coal. The supplemental thermal energy reduces the amount of electricity needed to dry the coal by 58,000 MW-hr per year. Because the thermal energy comes from a non-carbon source, this results in a reduction of 70,000 tons of emissions of carbon dioxide per year.

Another benefit of the approach in Example II is that the thermal energy from the non-carbon source is stored in the increased energy density coal and is converted into a form that can then be used to generate electricity on demand. In a conventional system to convert thermal energy to electricity, the thermal energy would have to be in the form of high pressure steam, and a steam turbine would be required to convert the thermal energy electricity. In the system in accordance with the invention set forth in Example II, 61,000 MW-hrs of low quality thermal energy in the form of a high temperature working fluid, is used to increase the energy density of coal, which is converted to 58,000 MW-hrs of electricity on demand in an existing coal fired boiler. It should be noted here that the conversion of thermal energy to electricity in conventional systems results in losses of greater than 50% of the energy. In the case described in Example II, the conversion occurs with minimal loss of energy.

Coal beneficiated with thermal energy produced by non-carbon sources is also capable of storing that thermal energy for a significant period of time, for several months up to a year or longer, as opposed to many other storage devices. For example, beneficiated coal may have a shelf life of at least 1 month, at least 2 months, at least 3 months, at least 4 months, at least 5 months, at least 6 months, at least 7 months, at least 8 months, at least 9 months, at least 10 months, at least 11 months, at least 12 months, at least 13 months, at least 14 months, at least 15 months, at least 16 months, at least 17 months, at least 18 months, at least 19 months, at least 20 months, at least 21 months, at least 22 months, at least 23 months, at least 24 months, or greater than 24 months, and any intervening ranges therein.

Integrating non-carbon thermal energy sources with coal beneficiation processes disconnects the timing of the energy stored in the coal during beneficiation from the timing of the use of the stored energy to satisfy customer demand. This is especially relevant in the case of non-carbon energy sources such as solar thermal, which is reliant on natural conditions beyond human intervention. The storage of thermal energy in beneficiated coal is highly efficient because most of the thermal energy stored from the non-carbon sources is recovered when the coal is burned to produce power. This is the case no matter which beneficiating process is used or which energy sources provide the energy including ones that use electricity generated from fossil fuels or renewable energy sources, waste energy, and/or thermal energy from any source, including fossil fuels and non-carbon energy sources. Furthermore, it allows the beneficiation facility to be located at the source of non-carbon thermal energy generation and the beneficiated coal can be used at another location without the need for transmission lines that are expensive and difficult to permit across private property, state and national borders.

In addition, the beneficiated coal can be shipped across oceans to other countries that are not possible to reach by transmission lines because of cost and practical limitations. The beneficiated coal represents stored energy that can be transported by truck, rail, barge, or ship across a continent, or around the world, to meet consumer demand for power.

Beneficiation of coal with heat from solar thermal, geothermal, and biomass combustion processes with or without further beneficiation can occur at the site where the non-carbon energy source is produced, where the coal is mined, at power plants where the coal is converted into energy or at transportation terminals that feed into multiple different plants. Alternatively, the coal beneficiation process can occur at all of the foregoing sites with or without further beneficiation of the coal. This means that at least the following combinations are possible. The coal beneficiation process, the coal power plant, and the coal mining can be at three different sites. The coal beneficiation process, the coal power plant, and the coal mining can be all at the same site. The coal beneficiation process and the coal mining can all be at the same site, with the coal power plant at a different site. The coal beneficiation process can be at one site, and the power plant and the coal mining at a different site or sites. Those of skill in the art will appreciate that further beneficiation of the coal after beneficiation may occur at any one of the sites listed above. These combinations may be further expanded to one or more additional sites.

In those embodiments where the coal beneficiation process is integrated with the operation of a coal power plant, i.e. located at the same site as the coal power plant, the coal beneficiation process can be integrated into the operation of the coal power plant in order to further increase the operational efficiency of the coal power plant. For example, waste heat generated from the combustion of coal at a power plant may be used to further supplement the thermal energy necessary to beneficiate coal to remove water therefrom. Interfacing the coal beneficiation process between the coal crusher and the pulverizer can save additional energy. This eliminates the need for separate coal crushing in the beneficiation process as well as eliminating the need for briquetting the beneficiated coal.

Integrating non-carbon thermal energy sources with the beneficiation of coal is compatible and complementary to the other means of reducing carbon emissions from coal-fired power plants including ultra- and supercritical plants and CCS technologies. In those embodiments where the beneficiation occurs at a coal mine (as discussed supra), such methods will reduce the amount of coal needed to be transported resulting in even further decreases in carbon emissions. Additionally, reducing the amount of moisture in the coal by beneficiating with heat will reduce the amount of coal being burned which will improve the operation of several plant systems resulting in reducing the parasitic power needed to run the plant. For example, it will lower the amount of pollutants and the volume of flue gas to be treated by air pollution control (APC) equipment. The reduced amount of coal will reduce the electrical power required to pulverize the coal. The resulting lower volume of combustion gases will also reduce the power required by the fans to move the gases. This will have an added benefit of reducing the pressure difference between the inside of the duct and the outside air resulting in lower in-leakage of air, which reduces the efficiency of the plants. All of these reductions in parasitic energy result in a decrease in the amount of CO₂ produced per unit of net electrical power generated by the plant. An additional benefit may be the generation of greater amounts of electricity at a plant that was originally designed for a higher heat content coal. This will allow the power company to optimize how much power is generated from a lower CO₂ emitting plant. The coal which is subject to coal beneficiation with supplemental thermal energy from non-carbon sources may be any type of coal, including peat coal, lignite coal, sub-bituminous coal, bituminous coal, and anthracite, although one of ordinary skill in the art will recognize that coal with higher water content such as sub-bituminous coal will benefit more from beneficiation than lower water content coal such as bituminous coal.

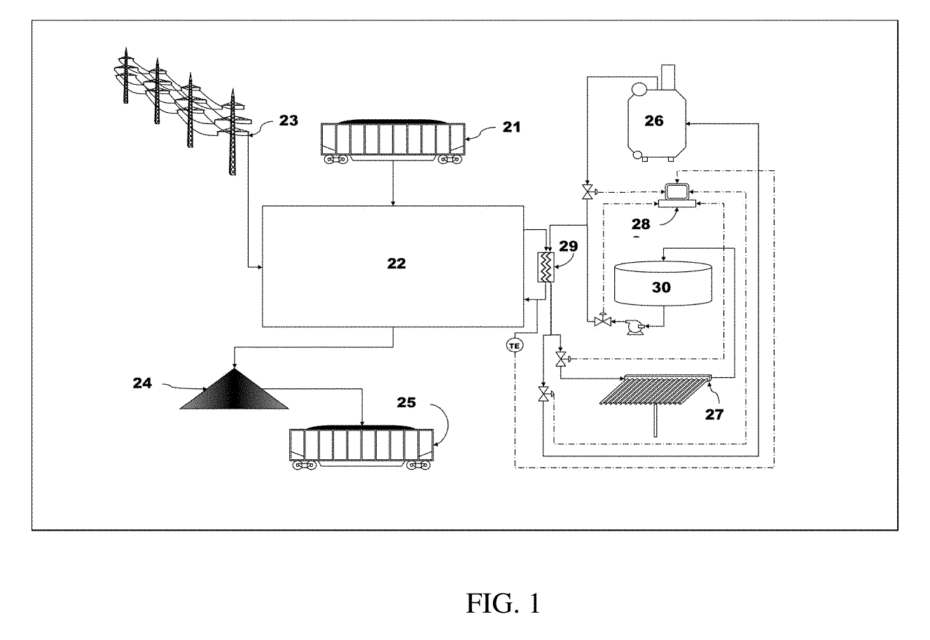

Referring now to FIG. 1 raw coal (21) is delivered to the coal processing plant (22) which dries and beneficiates the coal with a higher energy content (24) which is then taken to a power plant by a unit of transportation (25) where it is burned to make electricity. The coal drying/beneficiation plant (22) requires both electrical power from an external source (23) and thermal energy or heat. In this configuration, the thermal energy is provided by a solar thermal system in which water or a working fluid is exposed to the sun in panels (27), which heats the fluid. The heated fluid is then stored in an insulated vessel (30) to store the thermal energy. The heated working fluid is then sent to a heat exchanger (29), which heats air, liquid, or steam, which is then used in the coal processing plant. A gas-fired boiler (26) is used to produce steam or heated working fluid to supplement the thermal energy from the solar thermal system. The temperatures, pressures, and flow rates from all of the components are measured electronically and sent to an automatic controller (28), which balances the system and insures that the proper quantity and quality of thermal energy is delivered to the coal processing plant.

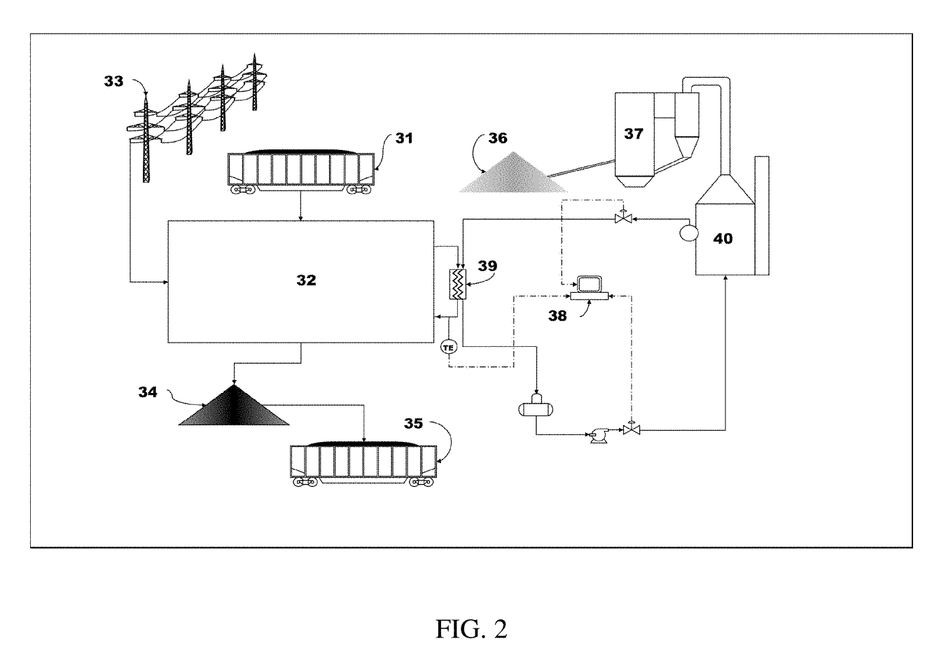

Referring now to FIG. 2 an alternate configuration of the invention is illustrated, wherein a biomass combustor is used to provide the necessary thermal energy required to process and dry the coal. Raw coal (31) is delivered to the coal processing plant (32) which dries and beneficiates the coal with a higher energy content (34) which is then taken to a power plant by a unit of transportation (35) where it is burned to make electricity. The coal drying/beneficiation plant (32) requires both electrical power from an external source (33) and thermal energy or heat. In this configuration, the thermal energy is provided by the combustion of biomass (36). The biomass is conveyed to the combustor (37), which burns the biomass to produce heat which is used to increase the temperature of either a working fluid or steam which is then stored in insulated vessel (40). The heated working fluid is then sent to a heat exchanger (39), which heats air, liquid, or steam, which is then used in the coal processing plant. The temperatures, pressures, and flow rates from all of the components are measured electronically and sent to an automatic controller (38), which balances the system and insures that the proper quantity and quality of thermal energy is delivered to the coal processing plant.

Thus, in some embodiments, the non-carbon energy source comprises a solar thermal energy source. Solar thermal energy has several distinct advantages and drawbacks. Solar thermal energy is totally non-carbon, and under certain conditions, such as those found in the American Southwest, is capable of generating high quantities of heat for the beneficiation of coal. One key advantage of solar thermal energy is that it is less expensive and more efficient than directly converting solar energy to electricity and then converting the electricity to thermal energy to burn coal. However, solar thermal energy systems are diurnal and only capable of generating heat when exposed to sunlight, thus their efficiency is limited. Thus, integrating solar thermal energy enhances coal beneficiation and allows for systems where any energy may be used to power the coal beneficiation process to provide a product that is capable of long-term storage and provide consistent output. In another embodiment concentrated solar power provides thermal energy to heat the coal during beneficiation. This simplifies the concentrated solar power system because it eliminates the need for the steam turbine, and also allows the system to operate at lower temperatures than steam conditions.

The non-carbon thermal energy sources reduce the need to combust fossil fuels to produce thermal energy to remove moisture thereby reducing carbon dioxide emissions associated with beneficiation thereby reducing the carbon footprint of the coal treatment plant.

The coal beneficiation process typically comprises reduction of the total water content of coal. Water is contained in coal in a number of different forms such as free water, bound water, and non-freezing water which are all included in the total water content of the coal. In this invention, the reduction of coal moisture is not bound by which type of moisture is impacted, only that overall reduction of any water is reduced. The water content reduction can be less than about 1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 25%, about 30%, about 35%, about 40%, about 45%, about 50%, about 55%, about 60%, about 65%, about 70%, about 75%, about 80%, about 85%, about 90%, about 95%, about 98%, about 99%, or greater than about 99%, and any intervening ranges therein. As defined herein, the water content reduction as measured by percent (%) water reduction is measured relative to the total water content of coal before and after beneficiation.

The coal beneficiation process increases the stored energy content of the coal, typically corresponding to reduction of the total water content of the coal. The stored energy content is typically, although not necessarily, measured in BTUs. The stored energy content may be increased by about 10%, about 20%, about 30%, about 40%, about 50%, about 60%, about 70%, about 80%, about 90%, about 100%, about 110%, about 120%, about 130%, about 140%, about 150%, about 160%, about 170%, about 180%, about 190%, about 200%, or greater than about 200%, and any intervening ranges therein.

The coal beneficiation process may follow the following methods, although variations on such methods are within one of ordinary skill in the art and are expressly considered embodied by the present disclosure. Typically, the coal is crushed into macerals, optionally washed, compacted, dried, and then briquetted although the crushing and washing stage may occur in different order. The crushing can occur by a number of means known in the art, including, but not limited to, through mechanical force, shredding, tearing, or through sonication/vibrations. At this stage, the coal is typically (but not necessarily) low ranking coal, such as lignite coal. Before or, ideally, after being pulverized or crushed into macerals, the macerals are optionally subjected to a washing step, i.e. coal washing. Coal washing is a process known in the art by which the coal is separated based on difference in specific gravity and impurities such as shale or sand, such that the impurities are “washed” out and what is left behind is purer coal with a higher calorific value. The coal washing can occur via a jig or some other gravity separation method, such as a dense medium bath or a dense medium cyclone. A number of dense medium baths exist including but not limited to teska bath, daniels bath, leebar bath, drewboy bath, barvoys bath, chance cone, wemco drums, tromp shallow bath, and combinations thereof. After the optional washing, the macerals are typically compacted, although not necessarily.

The coal product may then be subjected to beneficiation using the supplemental thermal energy from non-carbon sources to reduce the amount of moisture in the coal. When coupled with further beneficiation such as electricity from fossil fuels, renewable energy sources, waste energy, thermal energy from any source, non-carbon energy, and combinations of the foregoing, the total stored energy content of the coal as measured in the total energy content of the coal (e.g. in BTUs) per unit mass (e.g. gram or kilogram) of the coal is increased. The water reduction produced by the zero-carbon thermal energy may occur via a number of means, but particularly by solar thermal, geothermal, biomass combustion and combinations of the foregoing. Typically, a source of heat is applied to the coal in order to evaporate and drive the water off.

The coal beneficiation process may occur at temperatures below a temperature at which coal and/or coal dust will spontaneously ignite. For example, the coal beneficiation process keeps the coal temperature below about 500° C., below about 475° C., below about 400° C., below about 375° C., below about 350° C., below about 325° C., below about 300° C., below about 275° C., below about 250° C., below about 225° C., below about 200° C., below about 225° C., below about 200° C., below about 175° C., below about 150° C., below about 125° C., below about 100° C., below about 95° C., below about 90° C., below about 85° C., below about 80° C., and any intervening ranges therein. Furthermore, in such embodiments, there is little to no oxidation or volatilization of the coal, thus leaving little to no harmful gasses or emissions from the beneficiation process, minimizing environmental impact.

As used herein and in the appended claims, the singular forms “a”, “and” and “the” include plural references unless the context clearly dictates otherwise.

Where a value of ranges is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

The term “about” refers to a range of values which would not be considered by a person of ordinary skill in the art as substantially different from the baseline values. For example, the term “about” may refer to a value that is within 20%, 15%, 10%, 9%, 8%, 7%, 6%, 5%, 4%, 3%, 2%, 1%, 0.5%, 0.1%, 0.05%, or 0.01% of the stated value, as well as values intervening such stated values.

Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

Each of the applications and patents cited in this text, as well as each document or reference, patent or non-patent literature, cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference in their entirety. More generally, documents or references are cited in this text, either in a Reference List before the claims; or in the text itself; and, each of these documents or references (“herein-cited references”), as well as each document or reference cited in each of the herein-cited references (including any manufacturer's specifications, instructions, etc.), is hereby expressly incorporated herein by reference.

1. A system for reducing the amount of electricity needed in a coal-fired power plant to beneficiate and reduce the moisture content of coal by using thermal energy from a non-carbon source and increase the energy density of coal prior to combustion comprising:
at least one non-carbon thermal energy source;
a coal processing plant configured to reduce the moisture content of coal and produce an increased energy density beneficiated coal, wherein said at least one non-carbon thermal energy source is used to reduce an electrical need of the coal processing plant; and
a coal-fired power plant configured to combust the increased energy density beneficiated coal thereby producing electricity on demand at an increased efficiency with reduced carbon dioxide emissions from the plant.

2.-29. (canceled)

30. The system of claim 1 wherein the non-carbon thermal energy source is selected from a solar thermal energy source, a geothermal energy source, a biomass energy source and combinations of the foregoing.

31. The system of claim 1 further comprising thermal energy from a fossil fuel combustor integrated with the at least one non-carbon thermal energy source and configured to supplement the at least one non-carbon thermal energy source.

32. The system of claim 1 wherein a location of the coal processing plant is selected from a coal mine, a coal transportation terminal, a coal-fired power plant, a same site as the non-carbon thermal energy source and combinations of the foregoing.

33. The system of claim 32 wherein the coal transportation terminal is selected from terminals providing access to a ship, barge, rail, truck and combinations of the foregoing.

34. The system of claim 1 wherein the coal processing plant is integrated with a coal-fired power plant and shares use of coal handling, coal crushing and coal conveying equipment.

35. The system of claim 1 wherein said increased energy density coal is configured to be stored, transported and later combusted to produce said electricity on demand.

36. The system of claim 1 wherein the at least one non-carbon thermal energy source is configured to be used in conjunction with the mechanical compression of coal during or prior to a beneficiation process.

37. The system of claim 1 in which the at least one non-carbon thermal energy source is configured to be used to convert electrical energy to microwave energy to reduce the moisture content of the coal.

38. The system of claim 1 wherein said non-carbon thermal energy source is configured to preheat the coal prior to processing.

39. The system of claim 1 further comprising a working fluid configured to transport thermal energy from the non-carbon source of thermal energy to the coal processing plant.

40. The system of claim 39 further comprising a heat exchanger to recover thermal energy from the working fluid for use in the coal processing plant.

41. A system to store thermal energy from a non-carbon source by using the thermal energy in a coal processing plant to decrease the moisture content of coal resulting in an increased energy density beneficiated coal that can be subsequently combusted to produce electricity on demand comprising:
at least one non-carbon thermal energy source;
a coal preparation plant for beneficiating the coal, wherein energy from the at least one non-carbon thermal energy source is stored in a beneficiated increased energy density coal, and a coal-fired power plant configured to recover the stored energy by combusting the beneficiated coal to produce electricity on demand at an increased efficiency.

42. The system of claim 41 wherein the at least one non-carbon thermal energy source is selected from a solar thermal energy source, a geothermal energy source, a biomass energy source and combinations of the foregoing.

43. The system of claim 41 wherein a location of the coal preparation plant is selected from a coal mine, a coal transportation terminal, a coal-fired power plant, a same site as the non-carbon thermal energy source and combinations of the foregoing.

44. The system of claim 43 wherein the coal transportation terminal is selected from terminals providing access to a ship, barge, rail, truck and combinations of the foregoing.

45. The system of claim 41 wherein the coal processing plant is integrated with a coal-fired power plant and shares use of coal handling, coal crushing and coal conveying equipment.

46. The system of claim 41 wherein said increased energy density coal is configured to be stored, transported and subsequently combusted to produce said electricity on demand.

47. The system of claim 41 wherein said at least one non-carbon thermal energy source is configured to preheat the coal prior to processing.

48. The system of claim 41 further comprising a working fluid configured to transport thermal energy from the at least one non-carbon source of thermal energy to the coal processing plant.

49. The system of claim 48 further comprising a heat exchanger configured to recover thermal energy from the working fluid for use in the coal processing plant.

50. The system of claim 41 further comprising a thermal storage system configured to store energy from the at least one non-carbon source of thermal energy for later use in the coal processing plant.

51. A system to convert low quality thermal energy from non-carbon energy sources to electricity on demand by using the low-quality thermal energy from non-carbon sources in a coal processing plant to reduce the moisture content of coal resulting in an increased energy density beneficiated coal that can be later combusted to produce electricity on demand comprising:
at least one non-carbon thermal energy source;
a coal preparation plant for beneficiating the coal, wherein the at least one non-carbon thermal energy source is configured to support the reduction of moisture content in the coal thereby producing the increased energy density beneficiated coal that stores the at least one non-carbon thermal energy source; and
a coal-fired power plant configured to convert the stored thermal energy in the coal to electricity on demand by combusting the increased energy density beneficiated coal at an increased efficiency.

52. The system of claim 51 wherein the non-carbon thermal energy source is selected from a solar thermal energy source, a geothermal energy source, a biomass energy source and combinations of the foregoing.

53. The system of claim 51 wherein a location of the coal preparation plant is selected from a coal mine, a coal transportation terminal, a coal-fired power plant, a same site as the non-carbon thermal energy source and combinations of the foregoing.

54. The system of claim 51 wherein the coal transportation terminal is selected from terminals providing access to a ship, barge, rail, truck and combinations of the foregoing.

55. The system of claim 51 wherein the coal processing plant is integrated with a coal-fired power plant and shares use of coal handling, coal crushing and coal conveying equipment.

56. The system of claim 51 wherein the at least one non-carbon thermal energy source is configured to preheat the coal prior to processing.

57. The system of claim 51 further comprising a working fluid configured to transport thermal energy from the at least one non-carbon thermal energy source to the coal processing plant.

58. The system of claim 57 further comprising a heat exchanger configured to recover thermal energy from the working fluid for use in the coal processing plant.
